(19) United States
(12) Patent Application Publication
(10) Pub. No.: US 2015/0234720 A1
(43) Pub. Date: Aug. 20, 2015

(54) STANDBY SYSTEM DEVICE, ACTIVE SYSTEM DEVICE, AND LOAD DISPERSION METHOD

(71) Applicant: NEC Corporation, Tokyo (JP)

(72) Inventor: Maki Ohno, Tokyo (JP)

(21) Appl. No.: 14/428,795

(22) PCT Filed: Sep. 6, 2013
(86) PCT No.: PCT/JP2013/074045

§ 371 Date: Mar. 17, 2015

(30) Foreign Application Priority Data
Sep. 27, 2012 (JP) 2012-214873

(51) Int. Cl. G06F 11/20

(52) U.S. Cl. CPC G06F 11/2007; G06F 2201/85

(57) ABSTRACT

A redundancy configuration system is configured from an active system device and a standby system device. The active system device acquires a portion of data from among stored data and outputs the portion of data, and carries out prescribed processing with respect to data that was not output. The standby system device carries out prescribed processing with respect to the portion of data when an indication of a fault in the active system device is not detected, and when the indication is detected, after having carried out the prescribed processing with respect to the portion of data, outputs a signal indicating that there is the indication. The active system device, which has received that signal, also outputs the data that was not output. The standby system device carries out the prescribed processing also with respect to the data that is input after the portion of data.

### TECHNICAL FIELD

The present invention relates to a standby system device, an active system device, a redundancy configuration system, and a load dispersion method, and particularly relates to the standby system device, the active system device, the redundancy configuration system, and the load dispersion method that reduce a processing load of the active system device.

### BACKGROUND ART

A redundancy configuration system that is configured from an active system and a standby system is conventionally known. The redundancy configuration system switches to the standby system and continues services provided by the system when the active system is no longer able to operate in a normal manner due to a fault or the like. A hot standby and a cold standby are known as methods for switching to the standby system.

A hot standby system is provided for when an active system device is no longer able to operate in a normal manner, in which a standby system device carries out the same operations as the active system device at all times, that is, carries out mirroring. Consequently, a redundancy configuration system that uses the hot standby system is able to immediately switch processing to the standby system device when the active system device is no longer able to operate in the normal manner. On the other hand, a cold standby system is a system in which the standby system device activates from when the active system device is no longer able to operate, to pass the processing of the active system device to the standby system device. In the redundancy configuration system that uses the cold standby, the standby system device does not operate while the active system device is operating in a normal manner, and operation costs can be suppressed.

An example of the redundancy configuration system in which the cold standby system is used is disclosed in PTL 1 mentioned hereinafter. A computer system of PTL 1 is provided with a main computer, a backup computer, and a shared auxiliary storage apparatus. Normally the main computer executes an on-line program and regularly saves image data in the shared auxiliary storage apparatus at prescribed periods. Meanwhile, an on-line environment and a development/testing environment are constructed in the backup computer at the same time; however, normally the on-line environment is in a suspended state and the development/testing environment is in an active state. If a fault occurs in the main computer, the backup computer switches the development/testing environment that was in effect up to that point in time to a suspended state, switches the on-line environment to an active state, and reads the image data stored in the shared auxiliary storage apparatus to execute the on-line program.

According to the aforementioned configuration and operation, the computer system of PTL 1 is able to start a backup operation in a short time without reactivating the backup computer.

Furthermore, an example of the redundancy configuration system in which the hot standby system is used is disclosed in PTL 2 mentioned hereinafter. A wireless communication system of PTL 2 is provided with first and second receivers, first and second output controllers, first and second transmitters, a transmission switching controller, and a transmission antenna. The first and second receivers output reception levels measured therein to the first and second output controllers. The first and second output controllers each control the transmission levels of transmission signals output from the first and second transmitters on the basis of the input reception levels. The transmission switching controller selects either of the transmission signals output from the first and second transmitters and outputs such from the transmission antenna. An output control unit of an active system sends a CPU (central processing unit) alarm to the transmission switching controller when the CPU of the output control unit has a fault. The transmission switching controller carries out system switching control in such a way that a transmission signal from a transmitter of a standby system is output from the transmission antenna.

According to the aforementioned configuration and operation, the wireless communication system is able to avoid a state in which transmission output is only able to be transmitted at a low value, which occurs due to the CPU of the output control unit having a fault.

### CITATION LIST

### Patent Literature

PTL 1: Japanese Laid-open Patent Publication No. Hei8-314874

PTL 2: Japanese Laid-open Patent Publication No. Hei10-276120

### SUMMARY OF INVENTION

However, in the redundancy configuration systems of PTL 1 and 2, the standby system device does not carry out the operation of the active system at all until a fault occurs in the active system device, or is merely performing the same operation as the active system device, and therefore there is a problem in that processing is concentrated in the active system device and the processing load thereof is not reduced. In addition, in the redundancy configuration systems of PTL 1 and PTL 2, the standby system device normally does not perform the operation of the active system, or merely carries out the same operation as the active system device, and therefore there also arises a problem in that the processing capacity of the redundancy configuration systems does not become equal to or greater than the processing capacity of the active system device.

One of the objects of the present invention is to provide a standby system device, an active system device, a redundancy configuration system, and a load dispersion method that solve the aforementioned problems.

A standby system device of an aspect of the present invention is a standby system device that forms a redundancy configuration with an active system device, in which, when an indication of a fault in the active system device is not detected, the standby system device carries out prescribed processing with respect to a portion of data that is input from the active system device from among data stored in the active system device, and, when the indication of the fault in the active system device is detected, after having carried out the prescribed processing with respect to the portion of data, outputs a signal indicating that there is the indication of the fault to the active system device, and, as a result, carries out the prescribed processing also with respect to data that is input after the portion of data.

An active system device of an aspect of the present invention is an active system device that forms a redundancy configuration with a standby system device, in which, the active system device acquires a portion of data from among stored data and outputs the portion of data to the standby system device, and carries out prescribed processing with respect to data that was not output, and also outputs the data that was not output, to the standby system device when a signal indicating that there is an indication of a fault is input.

A redundancy configuration system of an aspect of the present invention is a redundancy configuration system configured from a standby system device and an active system device, in which, when an indication of a fault in the active system device is not detected, the standby system carries out prescribed processing with respect to a portion of data that is input from the active system device from among data stored in the active system device, and, when the indication of the fault in the active system device is detected, after having carried out the prescribed processing with respect to the portion of data, outputs a signal indicating that there is the indication of the fault to the active system device, and, as a result, carries out the prescribed processing also with respect to data that is input after the portion of data, and the active system device acquires the portion of data from among the stored data and outputs the portion of data to the standby system device, and carries out prescribed processing with respect to data that was not output, and, when the signal indicating that there is the indication of the fault is input, also outputs the data that was not output, to the standby system device.

A load dispersion method of an aspect of the present invention is a load dispersion method in a redundancy configuration system configured from a standby system device and an active system device, in which the active system device acquires a portion of data from among stored data and outputs the portion of data to the standby system device, and carries out prescribed processing with respect to data that was not output, when an indication of a fault in the active system device is not detected, the standby system device carries out prescribed processing with respect to the portion of data that is input from the active system device, and, when the indication of the fault in the active system device is detected, after having carried out the prescribed processing with respect to the portion of data, outputs a signal indicating that there is the indication of the fault to the active system device, the active system device also outputs the data that was not output, to the standby system device when the signal indicating that there is the indication of the fault is input from the standby system device, and, as a result, the standby system device carries out the prescribed processing also with respect to data that is input after the portion of data.

### BRIEF DESCRIPTION OF DRAWINGS

FIG. 1 is a diagram illustrating an exemplary configuration of a redundancy configuration system in a first exemplary embodiment.

FIG. 2 is a specific example of a processing quantity determination table in the first exemplary embodiment.

FIG. 3 is a chart for illustrating a normal operation of the redundancy configuration system in the first exemplary embodiment.

FIG. 4 is a chart for illustrating a normal operation (an operation in which a client terminal 40 acquires information) of the redundancy configuration system in the first exemplary embodiment.

FIG. 5 is a chart for illustrating an operation when a fault indication is detected of the redundancy configuration system in the first exemplary embodiment.

FIG. 6 is a diagram illustrating an exemplary configuration of a redundancy configuration system in a second exemplary embodiment.

FIG. 7 is a chart for illustrating a normal operation of the redundancy configuration system in the second exemplary embodiment.

FIG. 8 is a specific example of a processing quantity confirmation table in the second exemplary embodiment.

FIG. 9 is a diagram illustrating an exemplary configuration of a redundancy configuration system in a third exemplary embodiment.

FIG. 10A is a block diagram illustrating one exemplary configuration of an active system device in the third exemplary embodiment.

FIG. 10B is a block diagram illustrating one exemplary configuration of a standby system device in the third exemplary embodiment.

### DESCRIPTION OF EMBODIMENTS

Exemplary Embodiments of the present invention will be described in detail with reference to the drawings.

### First Exemplary Embodiment

### Description of Configuration

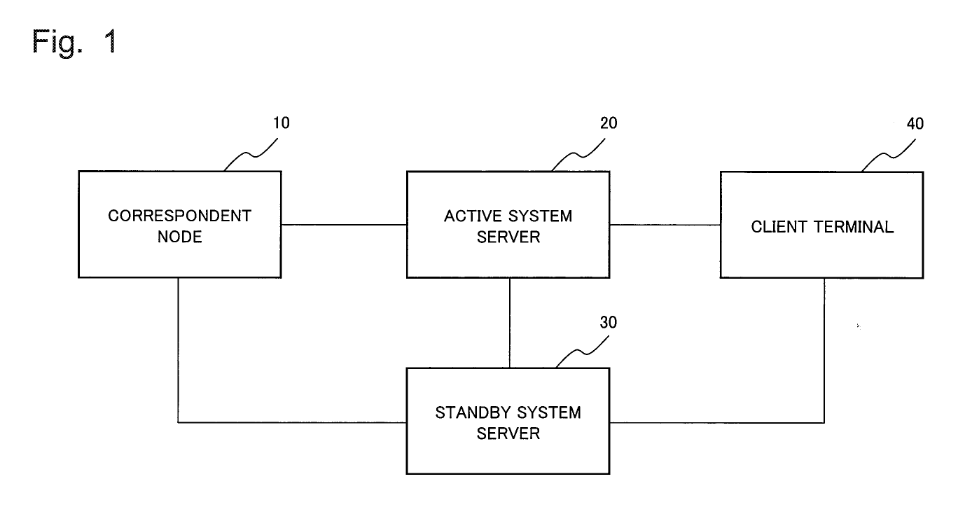

FIG. 1 is a diagram illustrating an exemplary configuration of the redundancy configuration system in the first exemplary embodiment.

(1) Configuration of the Redundancy Configuration System in the First Exemplary Embodiment

As shown in FIG. 1, the redundancy configuration system in the first exemplary embodiment is provided with a correspondent node 10, an active system server 20, a standby system server 30, and a client terminal 40. The active system server 20 is connected to the correspondent node 10, the standby system server 30, and the client terminal 40 by a wired circuit. Furthermore, the standby system server 30 is connected to the correspondent node 10 and the client terminal 40 by a wired circuit.

The correspondent node 10 is an device or system that measures general performance data and outputs that performance data to the active system server 20 and the standby system server 30. For example, the correspondent node 10 may be a cellular base station (eNB: evolved node B) or an MMS (mobile multimedia switching system), and may be a router or a switch. Various kinds of traffic data such as a resource usage state, a line communication state, and a call loss state can be given as examples of performance data when the correspondent node 10 is a cellular base station (eNB).

The active system server 20 and the standby system server 30 are servers for maintenance monitoring that process the performance data. For example, the active system server 20 and the standby system server 30 may be servers for maintenance monitoring that constitute an NMS (network management system) or an EMS (element management system).

(2) Function of Each Device Constituting the Redundancy Configuration System

The functions of the correspondent node 10, the active system server 20, the standby system server 30, and the client terminal 40 are described hereinafter.

The correspondent node 10 has a function to measure performance data. When a performance data request signal requesting the acquisition of performance data is input, the correspondent node 10 outputs performance data measured up to that point in time.

When a signal designating a data quantity is input, the active system server 20 stores that signal in a memory provided therein. Furthermore, when a prescribed timing is reached, the active system server 20 outputs a performance data request signal requesting acquisition of performance data to the correspondent node 10. The prescribed timing is set in the active system server 20 by a user of the redundancy configuration system of the present exemplary embodiment. The active system server 20 stores performance data input from the correspondent node 10 as a result of having output the performance data request signal, in the memory provided therein.

Furthermore, when storing the performance data in the memory, the active system server 20 acquires the signal designating a data quantity from the memory. In addition, the active system server 20 acquires performance data of a data quantity indicated by the aforementioned signal designating a data quantity and outputs the performance data to the standby system server 30. The active system server 20 deletes the output performance data from the memory.

Note that when a signal designating a data quantity is not input and may not be acquired from the memory, the active system server 20 acquires performance data of a prescribed data quantity from the memory and outputs the performance data. The prescribed data quantity is set in the active system server 20 by the user of the redundancy configuration system of the present exemplary embodiment.

In addition, the active system server 20 carries out, in the stored order, prescribed processing with respect to the remaining performance data that was not output. The prescribed processing is set in the active system server 20 by the user of the redundancy configuration system of the present exemplary embodiment. The active system server 20 stores data newly generated as a result of having carried out the prescribed processing, in the memory. Furthermore, the active system server 20 measures server data when a signal requesting server data is input from the standby system server 30. The server data is the processing load quantity of the active system server 20. For example, the server data may be the CPU (central processing unit) utilization rate of the active system server 20, and when access such as health checks is carried out frequently between the correspondent node 10 and the active system server 20, the server data may be that access frequency.

The active system server 20 outputs measured server data to the standby system server 30. In addition, when a signal requesting a processing result is input from the client terminal 40, the active system server 20 outputs that signal to the standby system server 30. When data is input from the standby system server 30 as a result of having output the signal requesting a processing result, the active system server 20 outputs both that data and newly generated data stored in the memory to the client terminal 40.

In addition, when a signal indicating that there is an indication of a fault is input, the active system server 20 outputs performance data stored in the memory to the standby system server 30. When all of the performance data stored in the memory is transferred to the standby system server 30, the active system server 20 outputs a signal indicating the end of the transfer.

Furthermore, when a signal indicating that there is an indication of a fault is input, the active system server 20 repeatedly confirms by means of a known function whether a fault has occurred therein, and upon each time of doing so, outputs a response reporting a fault occurrence, to the standby system server 30 if a fault has occurred. Furthermore, if a fault has not occurred therein, the active system server 20 outputs a response reporting that there is no fault to the standby system server 30. The signals that report whether or not there is a fault correspond to report signals. In addition, when a reset signal is input, the active system server 20 resets itself and starts an operation as the standby system server 30.

When the prescribed timing is reached, the standby system server 30 measures the processing load quantity thereof. The processing load quantity may be a CPU utilization rate. The prescribed timing is set in the standby system server 30 by the user of the redundancy configuration system of the present exemplary embodiment. In addition, when the standby system server 30 determines a signal designating a data quantity and associated with the measured processing load quantity from the processing quantity determination table, the standby system server 30 outputs that signal to the active system server 20 as a signal designating a data quantity. The processing quantity determination table is a table in which processing load quantities and signals designating a data quantity are associated. The processing quantity determination table is set in the active system server 20 by the user of the redundancy configuration system of the present exemplary embodiment.

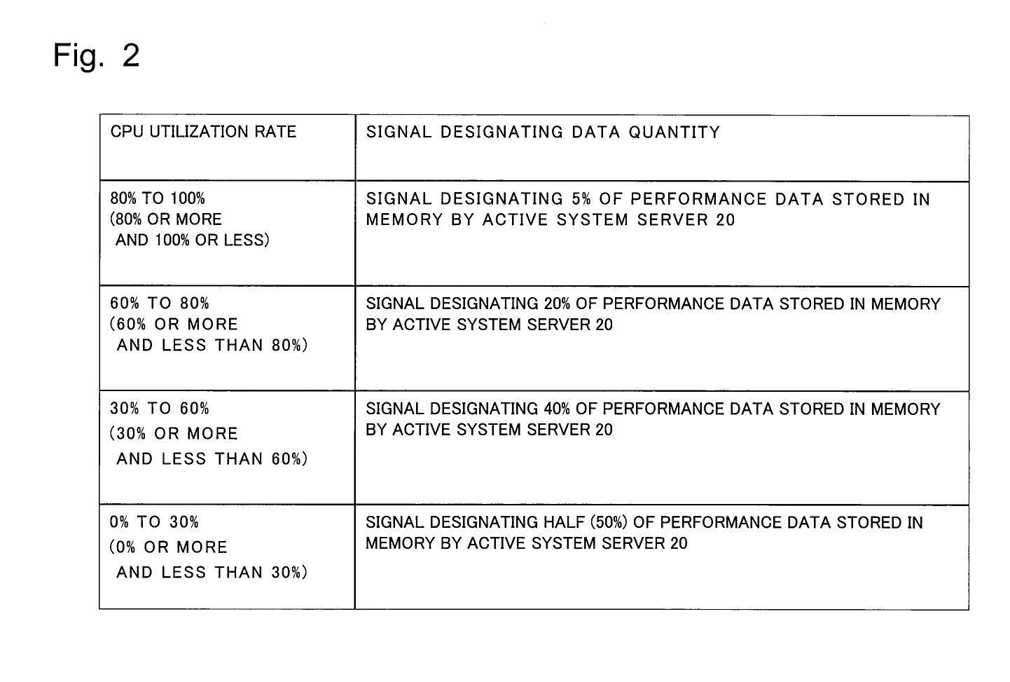

FIG. 2 is a specific example of the processing quantity determination table in the first exemplary embodiment. For example, when a measured processing load quantity, namely the CPU utilization rate, is 20%, the standby system server 30 outputs a signal designating half of the performance data stored in the memory by the active system server 20, to the active system server 20 as a signal designating a data quantity. The signal designating a data quantity is a signal designating some of the performance data stored in the memory by the active system server 20.

When performance data is input from the active system server 20 as a result of having output the signal designating a data quantity, the standby system server 30 stores the performance data in the memory provided therein, and carries out prescribed processing in the storage order. The prescribed processing is set in the standby system server 30 by the user of the redundancy configuration system of the present exemplary embodiment. This prescribed processing may be the same processing as the prescribed processing carried out by an active system device 520. The standby system server 30 stores data newly generated as a result of having carried out the prescribed processing, in the memory.

In addition, the standby system server 30 outputs a signal requesting server data, to the active system server 20 at prescribed periods. The prescribed periods are set in the standby system server 30 by the user of the redundancy configuration system of the present exemplary embodiment. Furthermore, the standby system server 30 detects whether there is an indication (sign) of a fault in the active system server 20 on the basis of server data input from the active system server 20. Specifically, the standby system server 30 confirms whether the server data input from the active system server 20, namely the CPU utilization rate or the access frequency, has exceeded a prescribed threshold value. The prescribed threshold value is set in the standby system server 30 by the user of the redundancy configuration system of the present exemplary embodiment. When the CPU utilization rate or the access frequency has exceeded the prescribed threshold value, the standby system server 30 determines that it has been detected that there is an indication of a fault in the active system server 20.

When the standby system server 30 is detected that there is an indication of a fault having occurred, the standby system server 30 outputs a signal indicating that there is an indication of a fault to the active system server 20. When a response reporting a fault occurrence is input from the active system server 20 as a result of having output the signal indicating that there is an indication of a fault, the standby system server 30 stores that response in the memory. When a signal indicating the end of transfer is input from the active system server 20, the standby system server 30 confirms the memory, and determines that a fault has occurred in the active system server 20 if a response reporting a fault occurrence is stored in the memory.

If the standby system server 30 is determined that a fault has occurred in the active system server 20, the standby system server 30 outputs a reset signal to the active system server 20 and, in addition, operates as the active system server 20. In addition, the standby system server 30 deletes the response reporting the fault occurrence from the memory. Furthermore, when a signal requesting a processing result is input from the active system server 20, the standby system server 30 outputs newly generated data stored in the memory to the active system server 20.

The client terminal 40 outputs a signal requesting a processing result, at prescribed periods. The prescribed periods are set in the client terminal 40 by the user of the redundancy configuration system of the present exemplary embodiment. The client terminal 40 displays input data on a screen provided therein.

### Description of Operation

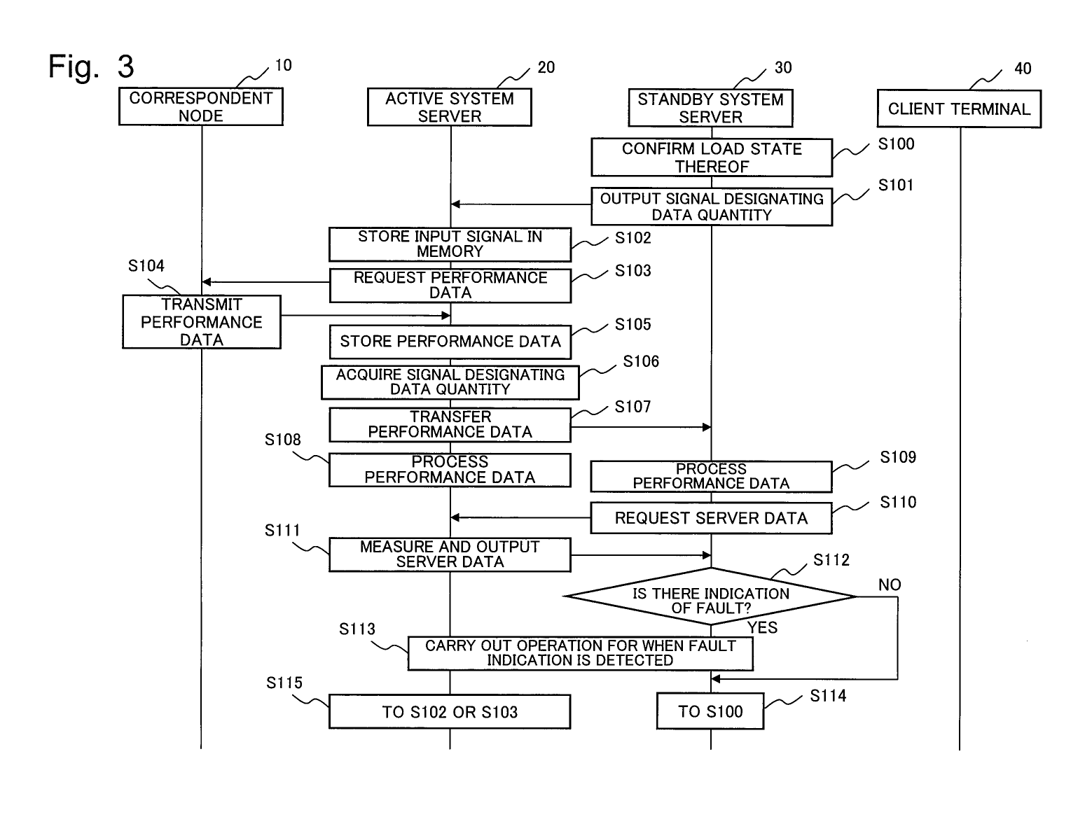

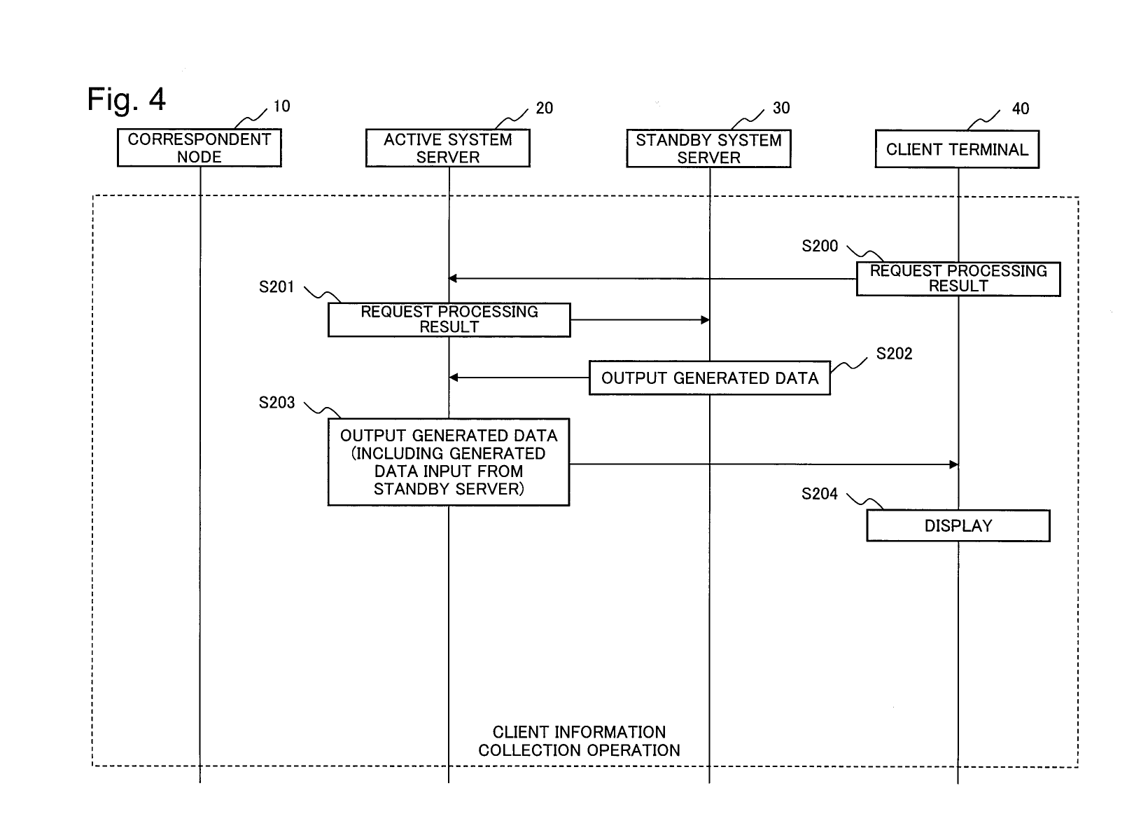

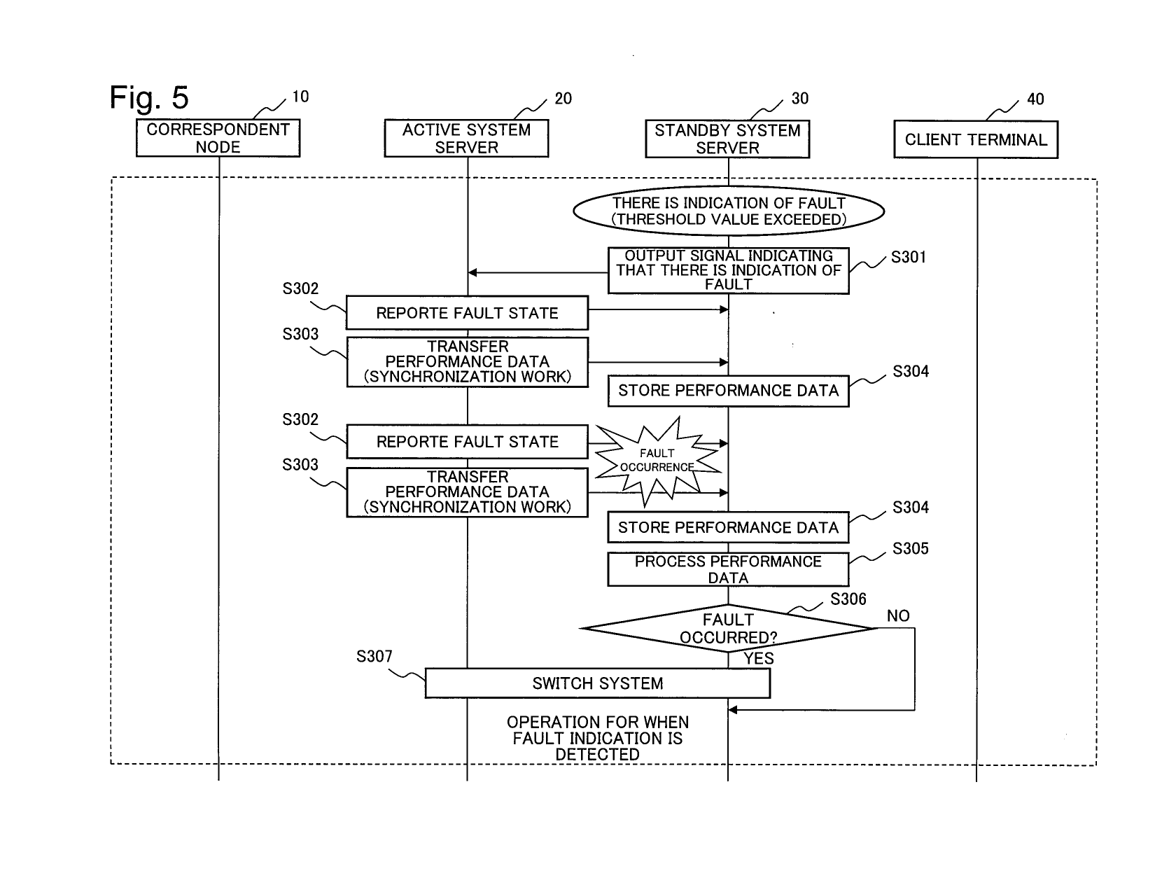

FIG. 3 is a chart for illustrating a normal operation of the redundancy configuration system in the first exemplary embodiment. Furthermore, FIG. 4 is a chart for illustrating a normal operation (an operation in which the client terminal 40 acquires information) of the redundancy configuration system in the first exemplary embodiment. In addition, FIG. 5 is a chart for illustrating an operation when a fault indication is detected of the redundancy configuration system in the first exemplary embodiment.

The aforementioned time when a fault indication is detected refers to when the standby system server 30 has detected that there is an indication of a fault in the active system server 20. A procedure for detecting that there is an indication of a fault in the active system server 20 is described by way of the processing of S110 to S113 mentioned hereinafter.

Hereinafter, the normal operation of the redundancy configuration system in the first exemplary embodiment and the operation when a fault indication is detected are each described using FIG. 3 to FIG. 5.

(1) Normal Operation of the Redundancy Configuration System

To begin, the normal operation of the redundancy configuration system of the present exemplary embodiment is described using FIG. 3.

First, as shown in FIG. 3, when a prescribed timing is reached, the standby system server 30 measures the processing load quantity thereof, for example, the CPU utilization rate (S100).

Note that when the standby system server 30 frequently performs access, such as health checks between the active system server 20 and the standby system server 30, that access frequency may be measured as the processing load quantity.

Next, the standby system server 30 determines a signal designating a data quantity and associated with the measured processing load quantity from the processing quantity determination table, and outputs that signal to the active system server 20 (S101).

For example, when the processing quantity determination table of FIG. 2 is set and the CPU utilization rate measured in S100 is 20%, the standby system server 30 outputs a signal designating half of the performance data stored in the memory by the active system server 20, as the signal designating a data quantity.

Next, when the signal designating the data quantity is input, the active system server 20 stores that signal in the memory provided therein (S102).

Next, when a prescribed timing is reached, the active system server 20 outputs a performance data request signal requesting performance data to the correspondent node 10 (S103).

The correspondent node 10 outputs performance data that has been measured up to that point in time to the active system server 20 (S104).

Next, the active system server 20 stores the input performance data in the memory provided therein (S105).

Furthermore, the active system server 20 acquires the signal designating a data quantity from the memory (S106).

Next, the active system server 20 acquires performance data of the data quantity indicated by the aforementioned signal designating a data quantity, and outputs the performance data to the standby system server 30 (S107).

For example, when the signal designating a data quantity is a signal designating half of the performance data stored in the memory by the active system server 20, the active system server 20 outputs half of the performance data stored in the memory to the standby system server 30. In addition, the active system server 20 deletes the output performance data from the memory.

Note that since the operations of the active system server 20 and the standby system server 30 are not synchronized, it is possible that the operation of S103 may be carried out before the aforementioned operation of S102. Thus, it is possible that a signal designating a data quantity may not be stored in the memory when the active system server 20 has carried out the operation of S103 immediately after activating. In such a situation, the active system server 20 acquires and outputs performance data of a prescribed data quantity from the performance data stored in the memory. Furthermore, it is also possible that the active system server 20 may carry out the processing of S102 while carrying out the processing of S103 and thereafter; however, in this situation, the processing of S102 is preferentially processed and carried out ahead of any of the processing of S103 and thereafter.

Next, the active system server 20 carries out, in the stored order, prescribed processing with respect to the remaining performance data stored in the memory that was not output in S107 (S108).

At such time, although not shown, the active system server 20 stores data (hereinafter referred to as “generated data”) newly generated as a result of having carried out the prescribed processing, in the memory.

Meanwhile, when the performance data is input, the standby system server 30 stores the performance data in the memory provided therein, and carries out prescribed processing in the storage order (S109).

Furthermore, although not shown, the standby system server 30 deletes the performance data for which the prescribed processing has been carried out, from the memory. In addition, the standby system server 30 stores data, namely generated data, newly generated as a result of having carried out the prescribed processing, in the memory.

Next, the standby system server 30 outputs a signal requesting server data to the active system server 20 at prescribed periods (S110). The signal requesting server data is a signal requesting output of a processing load quantity.

Next, when the signal requesting server data is input, the active system server 20 measures the server data thereof, namely the processing load quantity, and outputs a signal associated with the measured server data to the standby system server 30 (S111).

The server data, namely the processing load quantity, may be a CPU utilization rate, and when access such as health checks is carried out frequently between the active system server 20 and the correspondent node 10, the server data may be that access frequency.

Note that since the operations of the active system server 20 and the standby system server 30 are not synchronized, it is possible that a signal requesting server data may be input from the standby system server 30 while the active system server 20 is carrying out the processing of S102 to S103 and S105 to S108. In this situation, the active system server 20 prioritizes the processing of S102 to S103 and S105 to S108, and waits until this processing is not being executed to carry out the processing of S111.

Next, when a signal associated with server data is input, the standby system server 30 comprehends the server data, namely the processing load quantity, from that signal and determines whether there is an indication of a fault in the active system server 20 on the basis of the comprehended processing load quantity (S112).

An indication of a fault refers to a state in which the processing load quantity of the active system server 20 is larger than a prescribed threshold value. Consequently, the aforementioned operation of S112 is, specifically, as follows.

First, the standby system server 30 determines whether or not the input server data, namely the CPU utilization rate of the active system server 20 or the access frequency, is greater than the prescribed threshold value, namely whether or not the prescribed threshold value has been exceeded. When the input server data is greater than the prescribed threshold value, the standby system server 30 detects that there is an indication that a fault has occurred in the active system server 20.

Next, when the standby system server 30 has detected that there is an indication that a fault has occurred in the active system server 20 (when “yes” in S112), the standby system server 30 carries out “(2) Operation of the Redundancy Configuration System (When a Fault Indication is Detected)” mentioned hereinafter (S113).

Next, when the standby system server 30 has not detected that there is an indication that a fault has occurred in the active system server 20 (when “no” in S112), the standby system server 30 returns to S100 and waits until the next operation timing (S114).

Meanwhile, if a signal indicating that there is an indication of a fault is not input even though a prescribed time has elapsed after outputting a signal associated with server data in the aforementioned S111, the active system server 20 waits until the start timing of S102 and the processing timing of S103 (S115). The aforementioned signal indicating that there is an indication of a fault is described in “(2) Operation of the Redundancy Configuration System (When a Fault Indication is Detected)” mentioned hereinafter. Furthermore, the active system server 20 deletes all of the performance data processed in the aforementioned S108 from the memory, and then waits until the start timing of S102 and the processing timing of S103.

Next, an operation relating to the client terminal 40 is described.

First, as shown in FIG. 4, the client terminal 40 outputs a signal requesting a processing result to the active system server 20 at each prescribed period (S200).

Next, when the signal requesting the processing result is input, the active system server 20 outputs that signal to the standby system server 30 (S201).

The active system server 20 waits until no other processing is being carried out for the processing of the aforementioned 5201 to be executed.

Next, when a signal requesting a processing result is input, the standby system server 30 outputs generated data stored in the memory to the active system server 20 (S202).

The standby system server 30 waits until no other processing is being carried out for the processing of the aforementioned S202 to be executed.

Next, when the generated data is input from the standby system server 30, the active system server 20 outputs both that data and generated data stored in the memory provided therein to the client terminal 40 (S203).

The active system server 20 waits until no other processing is being carried out for the processing of the aforementioned 5203 to be executed.

Next, when the generated data is input, the client terminal 40 displays that data on the screen provided therein (S204). The client terminal 40 may process the input data to be displayed as a graph on the screen.

(2) Operation of the Redundancy Configuration System When a Fault Indication is Detected

Next, the operation of the redundancy configuration system of the present exemplary embodiment when a fault indication is detected is described hereinafter using FIG. 5. In the operation hereinafter, when a fault has occurred in the active system server 20, the standby system server 30 synchronizes work with the active system server 20 in such a way that system switching can be performed promptly. As a result of having carried out the processing hereinafter, the standby system server 30 carries out the same operation as a standby system server of a general hot standby system.

First, when the standby system server 30 has been detected that there is an indication of a fault in the active system server 20, the standby system server 30 outputs a signal indicating that there is an indication of a fault to the active system server 20 (S301).

Next, when the signal indicating that there is an indication of a fault is input, the active system server 20 reports a fault state to the standby system server 30 at prescribed periods (S302).

Specifically, the active system server 20 confirms whether a fault has occurred therein by means of a known function at each prescribed period, and outputs a response reporting a fault occurrence to the standby system server 30 if the fault has occurred therein. Furthermore, if the fault has not occurred therein, the active system server 20 outputs a response reporting that there is no fault to the standby system server 30. The prescribed period is set in the active system server 20 by the user of the redundancy configuration system of the present exemplary embodiment. Although not shown, when the response reporting the fault occurrence is input, the standby system server 30 stores that response in the memory.

In addition, the active system server 20 carries out synchronization work with which the processing of the active system server 20 is transitioned to the standby system server 30 (S303).

Specifically, the active system server 20 outputs performance data stored in the memory that was not output in the aforementioned S107, to the standby system server 30. Note that when the performance data is output, the active system server 20 does not delete that performance data from the memory. Furthermore, during the output of the performance data, when the S302 operation timing, namely the period in which a fault state is reported to the standby system server 30, is reached, the active system server 20 temporarily suspends the output of the performance data and preferentially carries out the processing of S302. When the processing of S302 is completed, the active system server 20 resumes the output of the performance data. In addition, although not shown, when the transfer of all of the performance data stored in the memory to the standby system server 30 has been completed, the active system server 20 outputs a signal indicating the end of the transfer.

Meanwhile, each time that performance data is input from the active system server 20, the standby system server 30 stores the performance data in the memory provided therein (S304).

Next, when the signal indicating the end of transfer is input, the standby system server 30 carries out prescribed processing in the storage order with respect to the performance data stored in the memory (S305).

Next, the standby system server 30 determines whether a fault has occurred in the active system server 20 (S306).

Specifically, the standby system server 30 confirms the memory and determines that a fault has occurred in the active system server 20 if a response reporting a fault occurrence is stored in the memory. Furthermore, the standby system server 30 may determine that a fault has occurred in the active system server 20 if no response whatsoever has been received from the active system server 20 within a prescribed time from a signal indicating that there is an indication of a fault being output. The prescribed time is set in the standby system server 30 by the user of the redundancy configuration system of the present exemplary embodiment.

Next, if the standby system server 30 is determined that a fault has occurred in the active system server 20 (when “yes” in S306), the standby system server 30 carries out system switching control by means of a known technique (S307).

In other words, the standby system server 30 notifies a reset signal to the active system server 20, and starts the operation from the aforementioned S102 or S103 as an active system server. Note that before the operation of the aforementioned S102 or S103 is started, the standby system server 30 deletes the response reporting the fault occurrence stored in the memory. Meanwhile, the active system server 20, which has received the reset signal, resets itself and then activates as a standby system server and starts the operation from the aforementioned S100. Note that the standby system server 30, which has activated as a new active system server, stores a signal designating that the data quantity is 0, as a signal designating a data quantity, immediately after activating. This is in order to ensure that performance data is not output until a new standby system server activates.

Note that, if the standby system server 30 has not been determined that a fault has occurred in the active system server 20 (when “no” in S306), the standby system server 30 returns to the aforementioned S100 and waits until the next operation timing.

Furthermore, in the aforementioned S303, when a reset signal has not been input even though a prescribed time has elapsed after a signal indicating the end of transfer has been output, the active system server 20 waits until the start timing of S102 and the processing timing of S103.

The aforementioned operation of the redundancy configuration system of the present exemplary embodiment when a fault indication is detected is carried out until the indication of the fault occurrence is no longer detected (when “no” in S112), or until system switching control is executed in S307.

### Description of Effect

According to the present exemplary embodiment, the redundancy configuration system can reduce the processing load imposed on the active system device. The reason therefor is because the standby system device that forms part of the redundancy configuration system of the present exemplary embodiment receives and processes some of the data to be processed, from the active system device.

In addition, the redundancy configuration system of the present exemplary embodiment can immediately switch to the standby system device when the active system device is no longer able to operate in a normal manner. The reason for being able to immediately switch to the standby system device is because the standby system device that forms part of the redundancy configuration system of the present exemplary embodiment detects that there is an indication of a fault in the active system device and, after detection, in preparation for system switching control, obtains in advance the data to be processed by the active system device, and carries out processing.

Furthermore, in the redundancy configuration system of the present exemplary embodiment, the standby system device and the active system device each carry out processing, and it is therefore possible for the processing capacity of the redundancy configuration system to be equal to or greater than the processing capacity of the active system device.

### Second Exemplary Embodiment

Next, a second exemplary embodiment is described. In the redundancy configuration system in the second exemplary embodiment, the difference between the processing load quantity of a standby system server 130 and the processing load quantity of an active system server 120 is confirmed, and the standby system server 130 receives data from the active system server 120 in such a way that the difference is eliminated.

### Description of Configuration

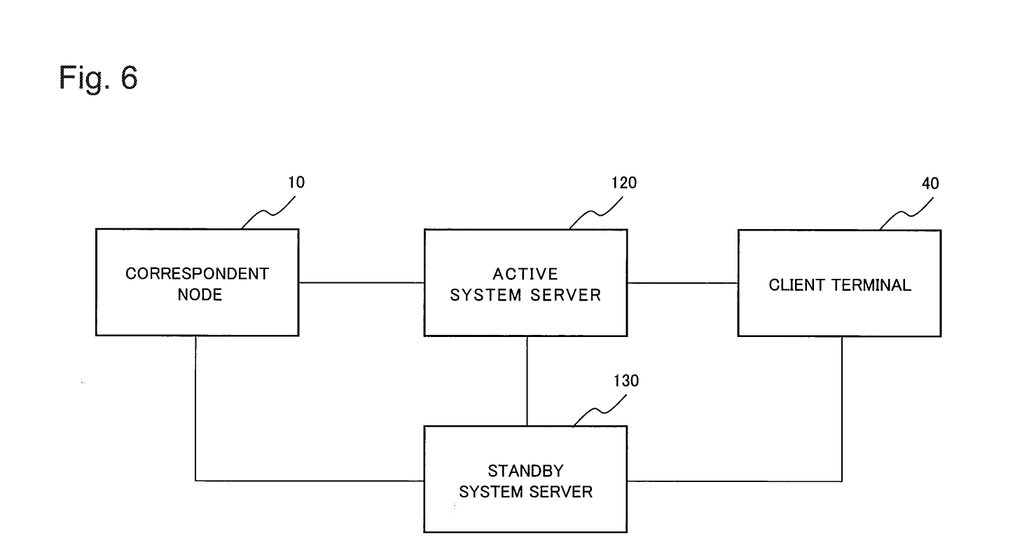

FIG. 6 is a diagram illustrating an exemplary configuration of the redundancy configuration system in the second exemplary embodiment. As shown in FIG. 6, the redundancy configuration system in the second exemplary embodiment is provided with the active system server 120 and the standby system server 130 instead of the active system server 20 and the standby system server 30.

When a prescribed timing is reached, the active system server 120 measures the processing load quantity thereof, namely the CPU utilization rate. In addition, the active system server 120 outputs a signal indicating the measured processing load quantity to the standby system server 130.

When the signal indicating the processing load quantity is input from the active system server 120, the standby system server 130 comprehends the processing load quantity of the active system server 120 from that signal. Furthermore, the standby system server 130 determines to what extent there is a difference between the measured processing load quantity thereof and the processing load quantity of the active system server 120. In other words, the standby system server 130 determines a value (hereinafter referred to as a “subtraction value”) obtained by subtracting the processing load quantity thereof from the processing load quantity of the active system server 120.

Furthermore, the standby system server 130 determines a signal designating a data quantity and associated with the determined subtraction value from the processing quantity determination table, and outputs that signal to the active system server 120 as a signal designating a data quantity. The processing quantity confirmation table is a table in which the aforementioned subtraction value and the signal designating a data quantity are associated. The processing quantity determination table is set in the active system server 120 by a user of the redundancy configuration system of the present exemplary embodiment.

Note that the configurations and functions other than the aforementioned are the same as the active system server 20 and the standby system server 30 of the redundancy configuration system of the first exemplary embodiment, and the same reference signs have therefore been appended and descriptions have been omitted.

### Description of Operation

FIG. 7 is a chart for illustrating a normal operation of the redundancy configuration system in the second exemplary embodiment.

First, as shown in FIG. 7, when a prescribed timing is reached, the active system server 120 measures the processing load quantity thereof, namely the CPU utilization rate (S400).

Next, the active system server 120 outputs a signal indicating the measured processing load quantity to the standby system server 130 (S401).

Next, the active system server 120 carries out the aforementioned S103 and S105 and stores performance data.

Meanwhile, when the signal indicating the measured processing load quantity is input, the standby system server 130 comprehends the processing load quantity of the active system server 120 from that signal, and, in addition, measures the processing load quantity of itself, namely the CPU utilization rate (S402).

Next, the standby system server 130 determines a value obtained by subtracting the processing load quantity thereof from the processing load quantity of the active system server 120, namely the subtraction value (S403).

Next, the standby system server 130 determines a signal designating a data quantity and associated with the determined subtraction value from the processing quantity determination table, and outputs that signal as a signal designating a data quantity (S404).

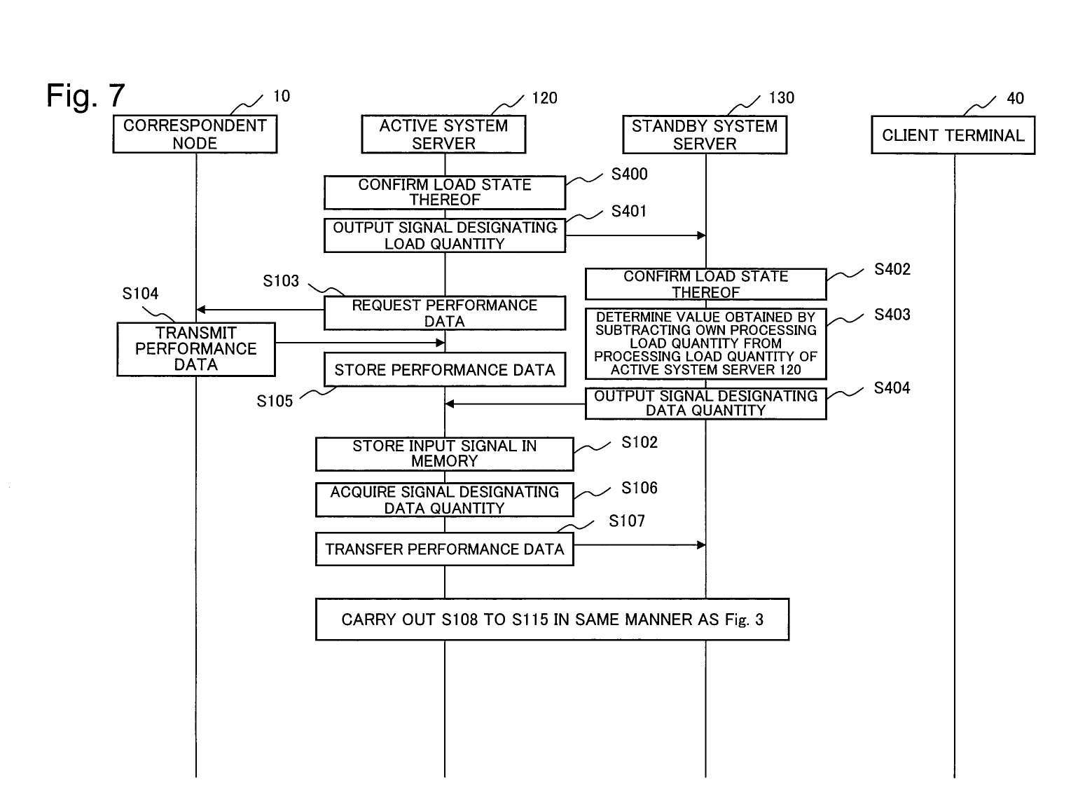

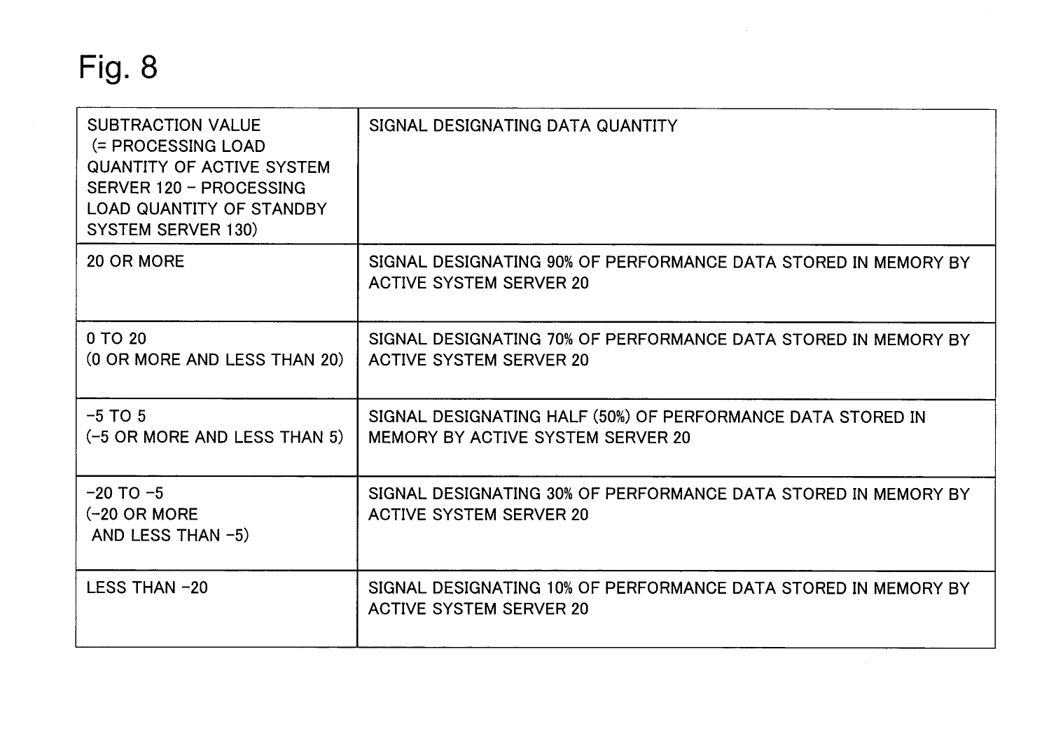

FIG. 8 is a specific example of the processing quantity confirmation table in the second exemplary embodiment. The user of the redundancy configuration system of the present exemplary embodiment sets signals designating data quantities in the processing quantity confirmation table in such a way that a difference between the processing load quantity of the active system server 120 and the processing load quantity of the standby system server 130 is eliminated. In other words, as shown in FIG. 8, the user of the redundancy configuration system of the present exemplary embodiment sets, when the subtraction value is a positive value, signals designating larger data quantities as that value becomes larger. In addition, the user of the redundancy configuration system of the present exemplary embodiment sets, when the subtraction value is a negative value, signals designating smaller data quantities as that absolute value becomes larger.

Next, when a signal designating a data quantity is input, the active system server 120 carries out the aforementioned S102, S106, and S107, and transfers data to be allotted to the standby system server 130 and processed.

The other operations are the same as the operations of the redundancy configuration system of the first exemplary embodiment, and descriptions of the details thereof have therefore been omitted.

### Description of Effect

According to the present exemplary embodiment, the redundancy configuration system can average the processing loads of the active system server 120 and the standby system server 130 to a greater extent that the redundancy configuration system of the first exemplary embodiment. The reason therefor is because the standby system server 130 of the redundancy configuration system of the present exemplary embodiment confirms the difference between the processing load quantity thereof and the processing load quantity of the active system server 120, and receives data of an quantity associated with the difference from the active system server 120 in such a way that the difference is eliminated.

### Third Exemplary Embodiment Next, a third exemplary embodiment is described.

### Description of Configuration

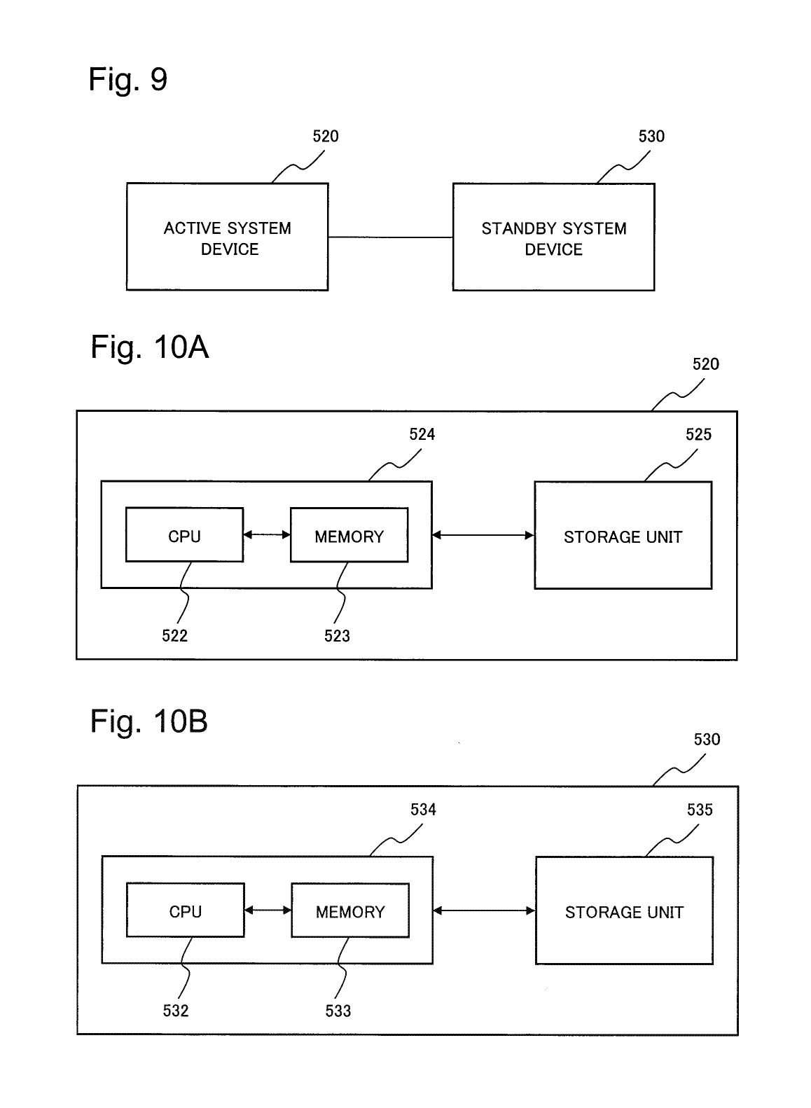

FIG. 9 is a diagram illustrating an exemplary configuration of a redundancy configuration system in the third exemplary embodiment. The redundancy configuration system in the third exemplary embodiment is configured from an active system device 520 and a standby system device 530. The active system device 520 and the standby system device 530 may be an active system server and a standby system server. Furthermore, the active system device 520 and the standby system device 530 may be connected by a wired circuit, or may be connected by a wireless circuit.

The active system device 520 acquires and outputs a portion of data from among stored data. Furthermore, the active system device 520 carries out prescribed processing with respect to the data that was not output. The prescribed processing is set in the active system device 520 by a user of the redundancy configuration system of the present exemplary embodiment. In addition, when a signal indicating that there is an indication of a fault is input, the active system device 520 also outputs the data that was not output when the aforementioned portion of data was output.

When an indication of a fault in the active system device 520 is not detected, the standby system device 530 carries out prescribed processing with respect to the portion of data input from among the data stored in the active system device 520, namely the aforementioned portion of data. The prescribed processing is set in the standby system device 530 by the user of the redundancy configuration system of the present exemplary embodiment. The prescribed processing may be the same processing as the prescribed processing carried out by the active system device 520. Furthermore, when an indication of a fault in the active system device 520 is detected, the standby system device 530 outputs a signal indicating that there is an indication of a fault, after having carried out the prescribed processing with respect to the aforementioned portion of data. The standby system device 530 carries out the prescribed processing also with respect to data that is input as a result of having output the signal indicating that there is an indication of a fault.

FIG. 10A is a block diagram illustrating one exemplary configuration of the active system device, and FIG. 10B is a block diagram illustrating one exemplary configuration of the standby system device 530.

As shown in FIG. 10A, the active system device 520 includes: a control unit 524 which includes a CPU 522 that executes prescribed processing in accordance with a program, and a memory 523 that stores the program; and a storage unit 525 for storing data to be processed.

As shown in FIG. 10B, the standby system device 530 includes: a control unit 534 which includes a CPU 532 that executes prescribed processing in accordance with a program, and a memory 533 that stores the program; and a storage unit 535 for storing data to be processed.

### Description of Operation

First, the active system device 520 acquires a portion of data from among stored data, and outputs the portion of data to the standby system device 530. Furthermore, the active system device 520 carries out prescribed processing with respect to the data that was not output.

Next, when an indication of a fault in the active system device 520 is not detected, the standby system device 530 carries out prescribed processing with respect to the aforementioned portion of data input from the active system device 520.

Next, when an indication of a fault in the active system device 520 is detected, the standby system device 530 outputs a signal indicating that there is an indication of a fault to the active system device 520 after having carried out the prescribed processing with respect to the aforementioned portion of data input from the active system device 520. When the signal indicating that there is an indication of a fault is input, the active system device 520 also outputs the aforementioned data that was not output, to the standby system device 530. As a result, the standby system device 530 carries out the prescribed processing also with respect to the input data.

Note that the standby system device 530 may carry out the detection of an indication of a fault in the active system device in the following manner.

First, the standby system device 530 outputs a request signal requesting the output of a processing load quantity, to the active system device 520. Next, when the request signal is input, the active system device 520 measures the processing load quantity thereof, and outputs a response signal corresponding to the measured processing load quantity, to the standby system device 530. The processing load quantity may be a CPU utilization rate. Next, when the response signal is input, the standby system device 530 determines whether or not the processing load quantity indicated by the response signal is larger than a prescribed value and, if it is larger, detects that there is an indication of a fault in the active system device. The prescribed value is set in the standby system device 530 by the user of the redundancy configuration system of the present exemplary embodiment.

### Description of Effect

According to the present exemplary embodiment, the redundancy configuration system can reduce the processing load imposed on the active system device. The reason therefor is because the standby system device that forms part of the redundancy configuration system of the present exemplary embodiment receives and processes some of the data to be processed, from the active system device.

Furthermore, in the redundancy configuration system of the present exemplary embodiment, the standby system device and the active system device each carry out processing, and it is therefore possible for the processing capacity of the redundancy configuration system to be equal to or greater than the processing capacity of the active system device.

An example of an effect of the present invention is that the redundancy configuration system can reduce the processing load imposed on the active system device.

Note that the aforementioned exemplary embodiments are not limited to those modes, and various alterations are possible without deviating from the purpose thereof in the implementation stage.

For example, the devices of the active system server and the standby system server in the first and second exemplary embodiments have different functions from the active system device and the standby system device in the third exemplary embodiment; however, the device configurations of the active system server and the standby system server in the first and second exemplary embodiments may be the same configurations as the active system device and the standby system device described with reference to FIG. 10A and FIG. 10B.

In addition, the whole or part of the exemplary embodiments disclosed above can be described as, but not limited to, the following supplementary notes.

(Supplementary Note 1)

A standby system device that forms a redundancy configuration with an active system device, wherein,

when an indication of a fault in the active system device is not detected, the standby system device carries out prescribed processing with respect to a portion of data that is input from the active system device from among data stored in the active system device, and, when the indication of the fault in the active system device is detected, after having carried out the prescribed processing with respect to the portion of data, outputs a signal indicating that there is the indication of the fault to the active system device, and, as a result, carries out the prescribed processing also with respect to data that is input after the portion of data.

(Supplementary Note 2)

The standby system device according to Supplementary Note 1, wherein

the standby system device outputs a signal designating a data quantity according to a processing load quantity thereof measured at a prescribed timing to the active system device, and, as a result, carries out the prescribed processing with respect to the portion of data that is input.

(Supplementary Note 3)

The standby system device according to Supplementary Note 2, wherein,

when a report signal associated with the processing load quantity is input, the standby system device determines a value obtained by subtracting the processing load quantity thereof from the processing load quantity of the active system device indicated by the report signal, namely a subtraction value, outputs a signal designating a data quantity according to the subtraction value, and, as a result, carries out the prescribed processing with respect to the portion of data that is input.

(Supplementary Note 4)

The standby system device according to Supplementary Note 2 or 3, wherein

the standby system device outputs a request signal requesting output of the processing load quantity, to the active system device in order to detect that there is the indication of the fault in the active system device, and, as a result, when a response signal corresponding to the processing load quantity is input, determines whether or not the processing load quantity indicated by the response signal is greater than a prescribed value.

(Supplementary Note 5)

An active system device that forms a redundancy configuration with a standby system device, wherein

the active system device acquires a portion of data from among stored data and outputs the portion of data to the standby system device, and carries out prescribed processing with respect to data that was not output, and also outputs the data that was not output, to the standby system device when a signal indicating that there is the indication of the fault is input.

(Supplementary Note 6)

The active system device according to Supplementary Note 5, wherein,

after a signal designating a data quantity is input, the active system device acquires data of the data quantity indicated by the signal from among the stored data and outputs the data to the standby system device.

(Supplementary Note 7)

The active system device according to Supplementary Note 5 or 6, wherein

the active system device outputs a report signal associated with the processing load quantity thereof measured at a prescribed timing.

(Supplementary Note 8)

The active system device according to any one of Supplementary Notes 5 to 7, wherein,

when a request signal requesting output of a processing load quantity is input, the active system device measures a processing load quantity thereof, and outputs a response signal corresponding to the measured processing load quantity to the standby system device.

(Supplementary Note 9)

A redundancy configuration system configured from a standby system device and an active system device, wherein

the standby system device is the standby system device according to any one of Supplementary Notes 1 to 4, and

the active system device is the active system device according to any one of Supplementary Notes 5 to 8.

(Supplementary Note 10)

A load dispersion method in a redundancy configuration system configured from a standby system device and an active system device, wherein

the active system device acquires a portion of data from among stored data and outputs the portion of data to the standby system device, and carries out prescribed processing with respect to data that was not output, when an indication of a fault in the active system device is not detected, the standby system device carries out prescribed processing with respect to the portion of data that is input from the active system device, and, when the indication of the fault in the active system device is detected, after having carried out the prescribed processing with respect to the portion of data, outputs a signal indicating that there is the indication of the fault to the active system device, the active system device also outputs the data that was not output, to the standby system device when the signal indicating that there is the indication of the fault is input from the standby system device, and, as a result, the standby system device carries out the prescribed processing also with respect to data that is input after the portion of data.

(Supplementary Note 11)

The load dispersion method according to Supplementary Note 10, wherein,

when a prescribed timing is reached, the standby system device measures the processing load quantity thereof, and outputs a signal designating a data quantity according to the processing load quantity to the active system device, and the active system device, after the signal designating the data quantity is input, acquires the data of the data quantity indicated by the signal from among stored data and outputs the data to the standby system device.

(Supplementary Note 12)

The load dispersion method according to Supplementary Note 11, wherein

the standby system device outputs a request signal requesting output of a processing load quantity, in order to detect that there is the indication of the fault in the active system device, the active system device measures a processing load quantity thereof and outputs a response signal corresponding to the measured processing load quantity to the standby system device when the request signal requesting output of the processing load quantity is input, and the standby system device determines whether or not the processing load quantity indicated by the response signal is greater than a prescribed value, when the response signal corresponding to the processing load quantity is input.

(Supplementary Note 13)

The standby system device according to any one of Supplementary Notes 1 to 4, wherein

the data is performance data.

(Supplementary Note 14)

The standby system device according to any one of Supplementary Notes 2 to 4 or Supplementary Note 12, wherein

the processing load quantity is a CPU (central processing unit) utilization rate.

(Supplementary Note 15)

The active system device according to any one of Supplementary Notes 5 to 8, wherein

the data is performance data.

(Supplementary Note 16)

The active system device according to any one of Supplementary Notes 5 to 8 or Supplementary Note 15, wherein

the processing load quantity is a CPU (central processing unit) utilization rate.

Heretofore, the invention of the present application has been described with reference to the exemplary embodiments; however, the invention of the present application is not limited to the aforementioned exemplary embodiments. Various alterations that are comprehensible to a person skilled in the art within the scope of the invention of the present application can be carried out with regard to the configuration and details of the invention of the present application.

Note that this application incorporates the entirety of the contents of Japanese Patent Application No. 2012-214873 filed on 27 Sep. 2012, and claims the priority on the basis of this Japanese Patent Application.

### REFERENCE SIGNS LIST

10 Correspondent node
20 Active system server
30 Standby system server
40 Client terminal
120 Active system server
130 Standby system server
520 Active system device
530 Standby system device

1. A standby system device that forms a redundancy configuration with an active system device, wherein,
when an indication of a fault in the active system device is not detected, the standby system device carries out prescribed processing with respect to a portion of data that is input from the active system device from among data stored in the active system device, and, when the indication of the fault in the active system device is detected, after having carried out the prescribed processing with respect to the portion of data, outputs a signal indicating that there is the indication of the fault to the active system device, and, as a result, carries out the prescribed processing also with respect to data that is input after the portion of data.

2. The standby system device according to claim 1, wherein
the standby system device outputs a signal designating a data quantity according to a processing load quantity thereof measured at a prescribed timing to the active system device, and, as a result, carries out the prescribed processing with respect to the portion of data that is input.

3. The standby system device according to claim 2, wherein,
when a report signal associated with the processing load quantity is input, the standby system device determines a value obtained by subtracting the processing load quantity thereof from the processing load quantity of the active system device indicated by the report signal, namely a subtraction value, outputs a signal designating a data quantity according to the subtraction value, and, as a result, carries out the prescribed processing with respect to the portion of data that is input.

4. The standby system device according to claim 2, wherein
the standby system device outputs a request signal requesting output of the processing load quantity, to the active system device in order to detect that there is the indication of the fault in the active system device, and, as a result, when a response signal corresponding to the processing load quantity is input, determines whether or not the processing load quantity indicated by the response signal is greater than a prescribed value.

5. An active system device that forms a redundancy configuration with a standby system device, wherein
the active system device acquires a portion of data from among stored data and outputs the portion of data to the standby system device, and carries out prescribed processing with respect to data that was not output, and also outputs the data that was not output, to the standby system device when a signal indicating that there is the indication of the fault is input.

6. The active system device according to claim 5, wherein,
after a signal designating a data quantity is input, the active system device acquires data of the data quantity indicated by the signal from among the stored data and outputs the data to the standby system device.

7. The active system device according to claim 5, wherein
the active system device outputs a report signal associated with the processing load quantity thereof measured at a prescribed timing.

8. The active system device according to claim 5, wherein,
when a request signal requesting output of a processing load quantity is input, the active system device measures a processing load quantity thereof, and outputs a response signal corresponding to the measured processing load quantity to the standby system device.

9. (canceled)

10. A load dispersion method in a redundancy configuration system configured from a standby system device and an active system device, wherein
the active system device acquires a portion of data from among stored data and outputs the portion of data to the standby system device, and carries out prescribed processing with respect to data that was not output,
when an indication of a fault in the active system device is not detected, the standby system device carries out prescribed processing with respect to the portion of data that is input from the active system device, and, when the indication of the fault in the active system device is detected, after having carried out the prescribed processing with respect to the portion of data, outputs a signal indicating that there is the indication of the fault to the active system device,
the active system device also outputs the data that was not output, to the standby system device when the signal indicating that there is the indication of the fault is input from the standby system device, and, as a result, the standby system device carries out the prescribed processing also with respect to data that is input after the portion of data.

11. The load dispersion method according to claim 10, wherein,
when a prescribed timing is reached, the standby system device measures the processing load quantity thereof, and outputs a signal designating a data quantity according to the processing load quantity to the active system device, and the active system device, after the signal designating the data quantity is input, acquires the data of the data quantity indicated by the signal from among stored data and outputs the data to the standby system device.

12. The load dispersion method according to claim 11, wherein
the standby system device outputs a request signal requesting output of a processing load quantity, in order to detect that there is the indication of the fault in the active system device, the active system device measures a processing load quantity thereof and outputs a response signal corresponding to the measured processing load quantity to the standby system device when the request signal requesting output of the processing load quantity is input, and the standby system device determines whether or not the processing load quantity indicated by the response signal is greater than a prescribed value, when the response signal corresponding to the processing load quantity is input.

13. The standby system device according to claim 1, wherein
the data is performance data.

14. The standby system device according to claim 2, wherein
the processing load quantity is a CPU (central processing unit) utilization rate.

15. The active system device according to claim 5, wherein
the data is performance data.

16. The active system device according to claim 5, wherein
the processing load quantity is a CPU (central processing unit) utilization rate.
